(19) United States
(12) Patent Application Publication
(10) Pub. No.: US 2010/0140276 A1
(43) Pub. Date: Jun. 10, 2010

(54) ENAMELLED AND ANODISED ARTICLE OF COOKWARE AND METHOD TO MANUFACTURE SAME

(75) Inventors: Pascal Cuillery, Faverges (FR); Jean-François Brassett, Annecy (FR); Fabrice Parsent, Mery (FR); Pierre-Jean Muller, Saint Felix (FR)

Correspondence Address: WINSTON & STRAWN LLP;PATENT DEPARTMENT, 1700 K STREET, N.W., WASHINGTON, DC, 20006, US

(73) Assignee: SEB SA, Ecully (FR)

(21) Appl. No.: 12/279,165

(22) PCT Filed: Feb. 14, 2007
(86) PCT No.: PCT/FR2007/000266

§ 371 Date: Nov. 11, 2008

(30) Foreign Application Priority Data
Feb. 14, 2006 (FR) 0601313
Dec. 5, 2006 (FR) 0610610

(51) Int. Cl. A47J 36/02; B21D 53/00; B23P 11/00; B23P 19/04

(52) U.S. Cl. 220/573.2; 29/460; 72/379.4; 220/912

(57) ABSTRACT

The invention relates to a culinary item comprising a dished body defining a bottom and a lateral wall, and provided with an inner surface for receiving food and an outer surface for positioning next to the heat source, at least one of the surfaces of the lateral wall being covered by an anodising layer and the outer surface of the bottom being at least partially enamelled. The invention also relates to a method for producing one such item.

The present invention relates to an enamelled and anodised article of cookware and a method to manufacture same.

Articles of cookware generally comprise a hollow bowl defining a bottom and a side wall, and having an inner face intended to receive foods and an outer face intended to be arranged on the side of the heat source. At least one of the faces of the side wall of said articles of cookware may be coated with an anodising layer.

Said anodising layer makes it possible to harden the coated surface superficially and render it particularly shock resistant and easy to clean. In addition, the anodising layer gives the surface coated with the anodising layer an appearance similar to that of slate, visually soft to the touch and which has a less cold appearance than a smooth aluminium or aluminium alloy surface.

Said articles of cookware may also have on the outer face thereof, an enamel layer which gives the surface coated in this way both an aesthetic finish, hardness and abrasion resistance.

The benefit of combining anodising and enamelling treatments is known in the prior art.

However, given that the adhesion of an enamel on an anodising layer is known to be very poor, the method to manufacture an enamelled and anodised article of cookware, for example a pan, must necessarily comprise an enamelling step prior to the anodising treatment.

However, those skilled in the art know that enamels are conventionally damaged by anodising treatment, with a significant loss in terms of the aesthetic qualities of the enamelling. In order to address this problem, a second enamelling treatment is performed after the anodising treatment to form a second so-called finishing enamel layer on that formed prior to the anodising treatment.

In this way, the U.S. Pat. No. 6,749,081 describes a surface treatment method of an aluminium or aluminium alloy article of cookware, which comprises the following successive steps:
a first enamelling step of the outer surface of the article, and
an anodising step of the inner surface of the article using a sulphuric acid solution, and
a second enamelling step of the previously enamelled outer surface of the article, to form a decorative enamel layer.

The second enamelling step in the method according to U.S. Pat. No. 6,749,081 compensates for the damage caused to the first enamel layer during the anodising step, and in particular restores the aesthetic qualities of the enamelling lost during anodising.

However, experience demonstrates that an article of cookware obtained by means of such a method has an insufficient resistance to dishwasher detergents.

In addition, the embodiment of an enamelled and anodised article of cookware according to the method of U.S. Pat. No. 6,749,081, is difficult to obtain, as this method comprises two enamelling steps, separated by an anodising step, which involves high installation and usage costs associated with the need for said second anodising step.

However, the applicant surprisingly discovered that it was possible to address these problems by controlling the integrity of the enamel layer, and the uniformity of the thickness thereof, thus making it possible to eliminate the finishing enamel layer.

More specifically, the applicant discovered that an enamel layer is capable of withstanding a subsequent anodising treatment if it has the following features:

1) a composition comprising 1.5 to 9% by weight with respect to the total weight of the enamel layer of at least one molten element selected from the group consisting of lead oxide PbO, bismuth oxide Bi₂O₃ and vanadium pentoxide V₂O₅;

2) a substantially uniform layer thickness, with a mean thickness value between 15 and 40 μm and a deviation with respect to said mean value of not more than 10%.

The applicant also discovered that it was possible to produce such a layer by means of the application and firing of at least one layer of anhydrous paste of a powdery enamel frit dispersed in a non-aqueous medium.

The aesthetic features provided by such an enamel layer render the production of a finishing enamel layer unnecessary.

In this way, the present invention relates to an article of cookware comprising a hollow bowl defining a bottom and a side wall rising from said bottom, said bowl having an inner face capable of receiving foods and an outer face intended to be arranged on the side of the heat source, said dish comprising an aluminium or aluminium alloy sheet.

According to the invention, the outer face at least of the side wall is made of anodised aluminium or anodised aluminium alloy, and the outer face of the bottom is coated at least partly with an enamel layer having a substantially uniform thickness wherein the mean value is between 15 and 40 μm, preferentially between 20 and 30 μm, with a deviation with respect to said mean thickness value of not more than 10%, said enamel layer comprising 1.5 to 9% by weight with respect to the total weight of the enamel layer of at least one molten element selected from the group consisting of lead oxide PbO, bismuth oxide Bi₂O₃ and vanadium pentoxide V₂O₅.

Preferentially, the molten element is vanadium pentoxide V₂O₅, found at a rate of 2 to 7% by weight with respect to the total weight of the enamel layer.

In a particularly advantageous embodiment of the invention, the enamel layer comprises 4 to 6% by weight of vanadium pentoxide V₂O₅ with respect to the weight of the enamel layer. This vanadium content range in the enamel layer guarantees a high resistance to acid corrosion and therefore to a sulphuric acid anodising treatment for the enamel layer.

Advantageously, the aluminium or aluminium alloy sheet is an embossed sheet having the final shape of the article of cookware according to the invention.

The term aluminium or aluminium alloy according to the present invention refers to a metal material comprising aluminium which meets the food contact suitability criteria in accordance with the decree dated 27 Aug. 1987.

Aluminium alloys that can be used according to the present invention particularly include alloys known for their suitability for enamelling, for example, 3003, 4006 and 4700 alloys. The preferred aluminium alloy is 3003 alloy.

An enamel frit which is not formulated in the form of anhydrous paste cannot be used to obtain the abovementioned features of the enamel layer.

Moreover, if the molten element content in the enamel layer is less than 1.5% by weight with respect to the total weight of said layer, it is very porous and the integrity thereof is not guaranteed. However, if the molten element content in the enamel layer is greater than 9% by weight with respect to the total weight of said layer, the enamel layer is not resistant to acid corrosion.

If the mean value of the thickness of the enamel layer is less than 15 μm (after firing), the enamel layer is not sufficiently tight and displays an insufficient resistance to acid corrosion and therefore to sulphuric acid anodising.

In an advantageous version of the invention, the inner face of the article of cookware according to the invention may be provided with a non-stick coating, which is arranged so as to be in direct contact with the aluminium sheet. This non-stick coating may be obtained using a composition comprising a thermostable resin resistant to at least 200° C.

Such a thermostable resin resistant to at least 200° C. conventionally comprises a fluorocarbon resin, alone or mixed with one or more other thermostable resins resistant to at least 200° C.

This fluorocarbon resin, wherein the hydrophobic properties are recognised, may be polytetrafluoroethylene (PTFE), the copolymer of tetrafluoroethylene and perfluoropropylvinylether (PFA) or the copolymer of tetrafluoroethylene and hexafluoropropylene (FEP) or a mixture of these fluorocarbon resins.

The other thermostable resins resistant to at least 200° C. may be a polyamide imide (PAI), a polyethylene sulphone (PES), a polyphenylene sulphide (PPS), a polyetherketone (PEK), or a polyetheretherketone (PEEK).

Therefore, these thermostable resins offer the specific advantage of withstanding an anodising treatment.

The present invention also relates to a method to manufacture an article of cookware according to the invention.

More specifically, the present invention relates to a method to manufacture an article of cookware comprising a bottom and a side wall rising from the aluminium or aluminium alloy base, which comprises the following steps:

a) shaping, by means of embossing, of an aluminium or aluminium alloy sheet 5 to give it the final shape of the article of cookware and thus define the inner face of the article of cookware, intended for cooking food, and the outer face of the article of cookware intended to be arranged on the side of the heat source; and

b) an enamel layer production step on all or part of the outer face of the bottom of the article of cookware, and

c) an anodising step of the article of cookware.

According to the invention, step b), performed before the anodising step c), represents the only enamelling step of the outer face of the bottom of the article of cookware according to the invention, said enamelling step b) comprising the following successive steps:

i. preparation of an anhydrous paste from a powdery enamel frit comprising 0.82 to 6.75% by weight with respect to the total weight of the paste of at least one molten element selected from the group consisting of lead oxide PbO, bismuth oxide Bi₂O₂ and vanadium pentoxide V₂O₅, said paste being formulated in the form of a dispersion in a non-aqueous medium;

ii. application of the anhydrous paste on the outer face of the bottom of the article of cookware in at least one layer;

iii. firing of the layer of paste at a temperature between 540° C. and 575° C., and preferentially at a temperature of approximately 560° C., to form an enamel layer having after firing a substantially uniform thickness wherein the mean value is between 15 and 40 μm with a deviation with respect to said mean thickness value of not more than 10%.

In order to produce an article of cookware according to the invention, an anhydrous paste comprising 1.1 to 5.25%, and preferentially 2.2 to 4.5% by weight of vanadium pentoxide V₂O₅ with respect to the total weight of the paste is preferentially used.

In the method according to the invention, the single enamel layer production step is performed before the anodising step, resulting in a reduction in the aluminium surface area exposed to anodising. Given that the cost of anodising is directly proportional to the aluminium surface area exposed in the anodising bath, the method according to the invention offers the advantage of being inexpensive.

The formulation of the enamel frit in the form of an anhydrous paste makes it possible to obtain an enamel layer offering resistance to a subsequent anodising treatment which is superior to that of an enamel layer obtained from a slip (i.e. an enamel frit dispersed in aqueous medium), and which therefore makes it possible to do away with the implementation of an enamelling step following the anodising without any loss in terms of the aesthetic qualities of the enamelling. The removal of this enamelling step after anodising also makes it possible to reduce the cost of such a method combining anodising and enamelling.

This method also offers the advantage of being compatible with any aluminium or aluminium alloy grade. Preferentially, 3003, 4006 and 4700 alloys are the aluminium alloys used. The preferred aluminium alloy is 3003 alloy.

Advantageously, the anhydrous paste comprises 55 to 75% by weight of powdery enamel frit with respect to the total weight of the paste. In fact, if the paste contains more than 75% by weight of enamel frit with respect to the total weight of the paste, said paste is too viscous and cannot be spread easily. However, if the paste contains less than 55% by weight of frit, the paste is much too fluid and needs to be deposited in several successive layers in order to obtain an enamel layer, after firing, having a sufficient thickness to withstand acid corrosion, which increases the overall cost of the method accordingly.

Preferentially, the anhydrous paste comprises 65% by weight of powdery enamel frit with respect to the total weight of the anhydrous paste. Such a paste has a sufficient fluidity to be spread easily during the application thereof, and also a sufficient consistency to enable the application of a single layer to obtain an enamel layer after firing of a mean thickness of at least 15 μm.

If the enamel frit is not in powder form, for example in flake form, it will be necessary to provide in the manufacturing method according to the invention for an additional dry grinding step of the enamel frit.

According to a particularly advantageous version of the invention, the enamel frit comprises:
SiO₂: 30 to 38%;
V₂O₅: 3 to 7;
NaOH: 15 to 25%;
LiOH: 0.5 to 4%;
KOH: 8 to 17%;
TiO₂: 18 to 25%;
   the contents specified being percentages by weight with respect to the weight of the frit.

In the anhydrous paste intended to form the enamel layer, the enamel frit is dispersed in a non-aqueous medium, which may be an oily medium or a solvent, preferentially having a high boiling point (particularly greater than 150° C.) and preferentially terpineol, white spirit (solvent of mineral origin, generally distilling between 130 and 200° C.) and mixtures thereof. In addition to the enamel frit, the anhydrous paste according to the invention may also comprise additional elements such as pigments, filters and/or opacifiers.

The anhydrous paste intended to form the enamel layer may be applied in various ways on the outer surface of the article of cookware according to the invention, and particularly by means of spraying (by means of a spray gun), with a screen, by means of screen printing or by means of stamp printing. Preferentially, this application is performed by means of screen printing or stamp printing.

The viscosity of the anhydrous paste is adapted according to the paste application technique selected. In this way, a paste having a viscosity of 2000 to 8000 Cp measured by means of a plane cone type viscosimeter will preferentially be applied by means of screen printing or stamp printing.

The anhydrous paste may be applied on the outer surface of the article of cookware in a single layer or in several layers.

According to a first embodiment of the invention, the anhydrous paste is applied in a single layer so as to form an enamel layer having after firing a mean thickness between 15 and 30 μm.

According to a second embodiment of the invention, the anhydrous paste is applied in two layers, so as to produce an enamel layer having after firing a thickness between 25 and 40 μm.

As an example of the application of the anhydrous paste in two layers, it is possible for example to envisage applying a first layer of anhydrous paste by means of screen printing to give a wet thickness of approximately 25 microns. This paste is then dried at 80° C. for 30 s, to give a “bisque” whereon a second layer of anhydrous paste having a wet thickness of approximately 25 microns is also applied by means of screen printing. This layer is also dried. Both layers are then oven-dried for 10 minutes at 560° C. to produce a vitrified enamel having a thickness of 35 microns.

The final anodising step is conventionally performed by tempering the article of cookware in a sulphuric acid bath, alone or in a mixture with oxalic acid, and with an acid bath temperature of −5° C. to 25° C. The DC voltage applied on the article may vary between 10 and 100 V.

Preferentially, the anodising is so-called “hard” anodising, performed in a sulphuric acid bath wherein the temperature is −5° C.

Advantageously, after the enamelling step b) and before the anodising step c) of the article of cookware, the deposition on the inner face of the article of cookware of at least one layer intended to form, after firing, a non-stick coating is performed. This non-stick coating is preferentially obtained from a composition comprising a thermostable resin resistant to at least 200° C., and preferentially a silicone resin or a fluorocarbon resin such as PTFE.

In this case, the deposition of a non-stick coating on the inner face of the article of cookware makes it possible to reduce the anodising cost by acting as a mask.

However, it is also possible to perform deposition of a non-stick coating on the inner face of the article of cookware after step c). In this case, the anodising layer on the inner face forms a reinforcing underlayer for the non-stick coating.

The anodising is generally completed by a hydrothermal sealing step, wherein the principle consists of converting the alumina Al₂O₃ formed during the anodising into alumina monohydrate. This results in a reduction in the porosity of the anodising layer. This treatment is performed by means of tempering in a water bath wherein the minimum temperature is 90° C. and the pH is between 5.5 and 6.5.

Other advantages and specificities of the present invention will result from the following description, given as a non-limitative example and made with reference to the appended figures:

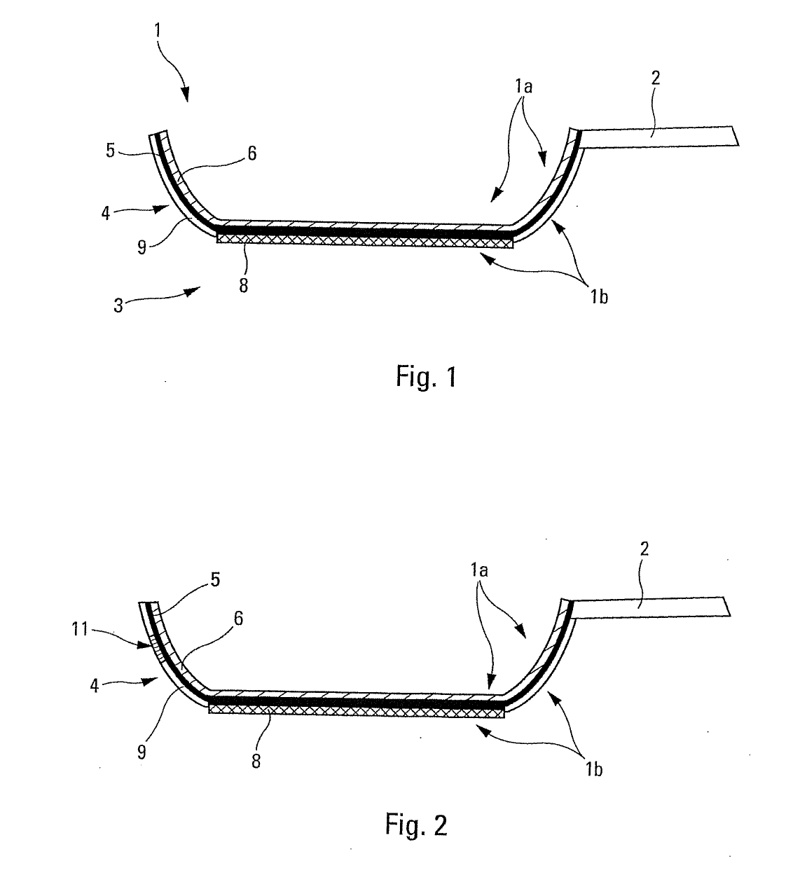

FIG. 1 represents a schematic sectional view of an article of cookware according to the invention according to a first alternative embodiment,

FIG. 2 represents a schematic sectional view of an article of cookware according to the invention according to a second alternative embodiment,

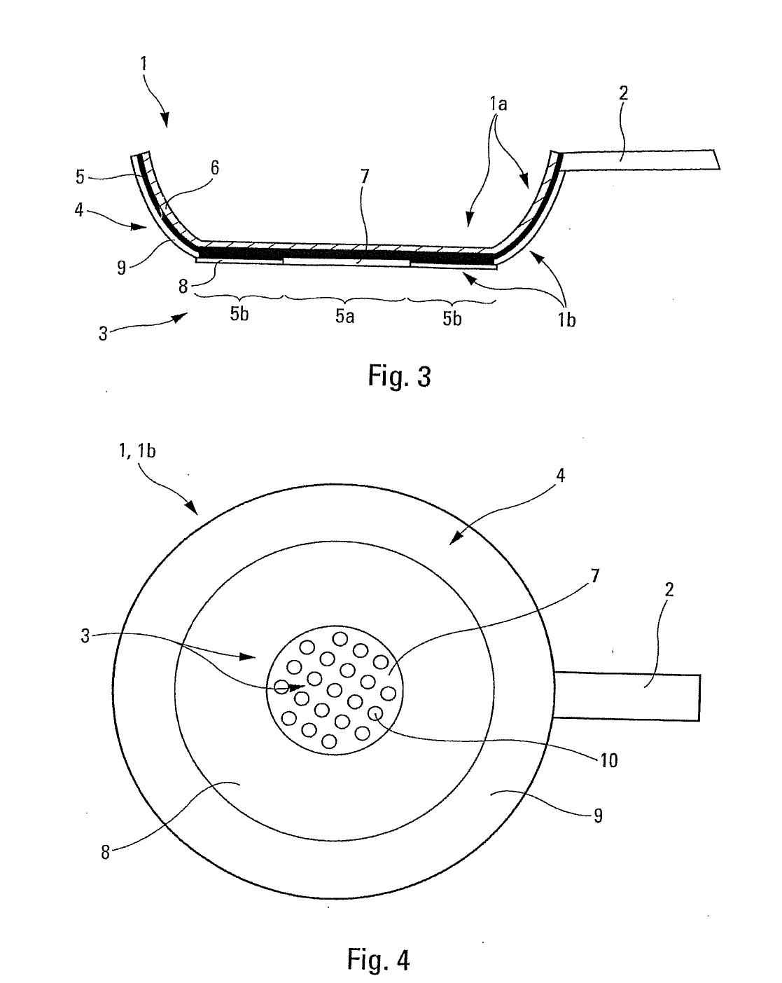

FIG. 3 represents a schematic sectional view of an article of cookware according to the invention according to a third alternative embodiment,

FIG. 4 represents a schematic projection view from below of the article of cookware represented in FIG. 3,

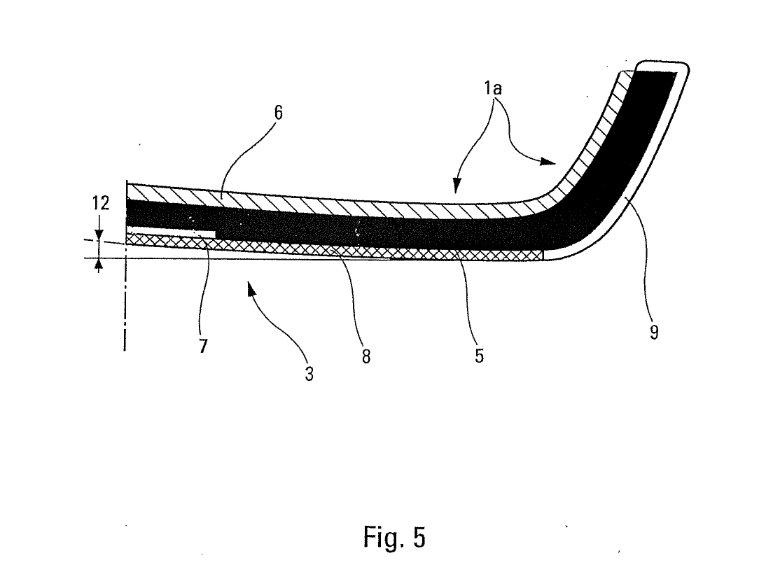

FIG. 5 represents a schematic sectional view of an article of cookware according to the invention according to a fourth embodiment,

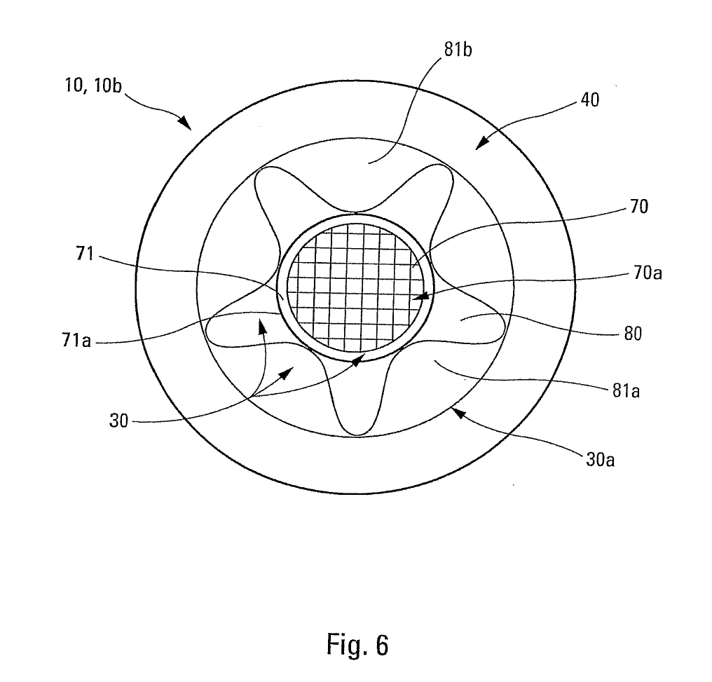

FIG. 6 represents a schematic projection view from below of the bottom of an article of cookware according to a fifth alternative embodiment.

Identical items represented in FIGS. 1 to 4 are represented by identical numerical references.

FIGS. 1 to 4 represent as an example of an article of cookware, a pan 1, comprising a handle 2, a bottom 3 and a side wall 4 rising from said bottom 3. The bottom 3 and the side wall 4 are produced from a sheet 5 having the shape of a disk. This sheet 5, which is made of aluminium or aluminium alloy, is embossed so as to have the final shape of the pan 1. The pan 1 comprises an inner face 1a intended for cooking foods and an outer face 1b intended to be arranged on the side of the heat source, such as a hob or a burner. The inner face 1a of the pan 1 is completely coated by a non-stick coating 6.

In FIGS. 1 and 2, the outer face 1b of the bottom 3 is entirely coated by an enamel layer 8 according to the invention.

In the alternative embodiment illustrated in FIG. 1, the outer face 1b of the side wall 4 is completely coated by an anodising layer 9.

In the alternative embodiment illustrated in FIG. 2, the outer face 1b of the side wall 4 comprises an anodising layer 9, which is intermitted by an enamel décor or patterns 11.

In the alternative embodiment illustrated in FIGS. 3 and 4, the outer face 1b of the bottom 3 comprises a plate 7 centred on the bottom 3 and covering a portion 5a of the sheet 5, along with an enamel layer 8 covering a portion 5b of the sheet 5.

The plate 7 is made of a metal or a material coated with a metal. In both cases, the metal of the plate 7 or the metal coating the material is selected such that it withstands an anodising step, i.e. it is not degraded by sulphuric acid-based treatment in the anodising bath.

In this way, the metal of the plate is more specifically selected from the transition metals such as titanium, zirconium or niobium, and is, preferentially, titanium.

The plate 7 may also be formed from a material coated with metal, the material forming the core of the plate 7 being advantageously selected from steel, stainless steel, ferritic or not. The metal coating said material is selected from the transition metals such as titanium, zirconium or niobium, or a carbide or a nitride of a transition metal such as titanium, zirconium or niobium.

If a material displaying ferromagnetic properties is used, the pan 1 according to the invention offers the advantage of being useable with an induction heating means. A suitable material for such a use is particularly AISI 430 stainless steel.

In the latter hypothesis, the plate 7 will be punched and will preferentially extend on the entire surface of the outer face 1b of the bottom 3.

The plate 7 may possibly consist of several components and therefore not be unitary. It is generally completely embedded in the sheet 5, so that the surface of the plate 7 is flush with that of the plate.

As represented visibly in FIG. 4, the plate 7 comprises, particularly advantageously, holes 10. These holes 10 may be coated with the enamel layer 8 according to the invention or, on the other hand, left free and therefore be made of anodised aluminium or anodised aluminium alloy.

If the holes 10 are coated with an enamel layer 8, said layer is preferentially transparent on the plate 7, so that it is visible for the consumer.

In the alternative embodiment illustrated in FIGS. 3 and 4, the outer face 1b of the bottom 3 is entirely covered by the plate 7 and the enamel layer 8, deposited on the portion 5b of the base 3 and in the holes 10.

However, it can be envisaged that the surfaces of the outer face 1b of the bottom 3 which are not covered by the plate 7 and by the enamel layer 8, are made of anodised aluminium or anodised aluminium alloy, as represented in FIG. 4 detailed hereinafter.

For the reasons already mentioned in the patent applications FR 2 711 050 and FR 2 711 051, whether for an article of cookware 1 compatible or not with an induction cooking mode, the plate 7 covers between 5 and 30% of the total surface area of the bottom 3. However, such a value of 30% is not limitative when trying to obtain an article of cookware also having ferromagnetic properties.

In a more specifically advantageous alternative embodiment represented in FIG. 5, the sheet 5 is embossed so as to provide a slight concavity 12 at the bottom 3 of the article of cookware 1. However, in the latter hypothesis, if the article of cookware is arranged on a hob, the bearing surface of the bottom 3, generally annular and referred to as the “bearing diameter”, is completely coated with the enamel layer 8 according to the invention to prevent any premature wear of the bottom 3 liable to occur if said bearing diameter were to be left in anodised aluminium or anodised aluminium alloy. Therefore, such an article of cookware offers a dual advantage, on one hand, of not being subject to deformation and, on the other, withstanding wear and, as such, not causing scratches or marks on a vitroceramic hob, in particular.

The anodising treatment may then be followed by a hydrothermal sealing step, which is performed by tempering in a water bath wherein the minimum temperature is 90° C. and the pH between 5.5 and 6.5.

In the alternative embodiment represented in FIG. 6, the bottom 30 of the article of cookware 10 comprises a plate 70 in the form of a grid embedded in the aluminium or aluminium alloy sheet and centred on the bottom 30.

In order to render the article of cookware 10 compatible with an induction heating mode, it is possible to use a plate provided with ferromagnetic properties, either directly via the metal of the plate 70 where said metal must likewise meet the anodising resistance requirements, or indirectly via the materials, if the plate 70 is formed by a material coated with metal.

On the periphery 70a of the grid 70, an annular groove 71 is provided. On the portion between the periphery 71a of said annular groove 71 and the periphery 30a of the bottom 30, the bottom 30 comprises an enamel layer according to the invention 80 forming a pattern and, apart from the zones coated with said enamel layer 80, anodised aluminium or anodised aluminium alloy surfaces 81a, 81b.

The outer face 10b of the side wall 40 is entirely made of anodised aluminium or anodised aluminium alloy.

The method to manufacture an article of cookware according to the invention will now be described. This method comprises the following successive steps, read with reference to FIGS. 1 to 4:
shaping, by means of embossing, of an aluminium or aluminium alloy sheet 5 to give it the final shape of the article of cookware 1, 10 and thus define the inner face of the article of cookware, intended for cooking food, and the outer face 1b, 10b, of the article of cookware intended to be arranged on the side of the heat source,
application, by means of die stamping, on the outer face 1b, 10b, of the bottom 3, 30, of a plate 7, 70 intended to cover at least a portion of the sheet 5, the plate 7, 70 being made of a metal or a material coated with a metal, said metal being selected so as to be able to withstand said anodising step,
application followed by firing, on all or part of the portion of the sheet 5 not covered by the plate 7, 70, whether on the bottom 3, 30 or the side wall 4, 40, of at least one layer of anhydrous paste according to the invention, to form, after firing, an enamel layer resistant to anodising,
deposition, at least on the entire inner face 1a of the article of cookware 1, 10, of at least one layer intended to form, after firing, a non-stick coating 6, and
anodising of the article of cookware 1, 10.

The final anodising step is preferentially so-called “hard” anodising, performed in a low-temperature sulphuric acid bath, preferentially at a temperature of the order of −5° C.

As already described above, a transition metal such as titanium, zirconium or niobium is used for the metal of the plate 7, 70 and, if applicable, steel or stainless steel, ferritic or not, is used as the material coated with said metal or with a carbide or nitride or such a metal.

Reference will be made to the above description for the attainment conditions required to form the enamel layer according to the invention 8, 80.

Numerous alternative embodiments may be made of the present invention, without leaving the scope of the present invention.

In particular, for aesthetic reasons, it is possible to envisage providing the outer face 1b, 10b of the side wall 4, 40 made of anodised aluminium with a décor produced by means of deposition of a coloured resin.

The following examples also illustrate the invention but without limiting the scope thereof.

### EXAMPLES

In the examples, unless specified otherwise, all the quantities are expressed in parts by weight.

### Example 1

An anhydrous paste according to the invention PA1 was prepared from an enamel frit according to the invention F1, wherein the composition is specified hereinafter in Table 1.

As a comparison, two control anhydrous pastes PA01 and PA02 were also prepared, from control enamel frits F01 and F02, respectively, wherein the compositions are also specified in Table 1. The enamel frits F01 and F02 are referred to as “controls” as, when they are formulated in anhydrous paste form, they display a molten element content (V₂O₅ or PbO) outside the claimed range.

TABLE 1

| | Composition (%) | | |
|---|---|---|---|
| | F1 | | |
| | according to | F01 | F02 |
| | invention | control | control |
| SiO₂ | 35 | 36 | 36 |
| V₂O₅ | 5 | 0 | 12 |
| PbO | 0 | 1.5 | 0 |
| NaOH | 21 | 21 | 20 |
| LiOH | 2 | 2 | 1 |
| KOH | 14 | 14 | 13 |
| TiO₂ | 23 | 25 | 20 |
| Total | 100 | 100 | 100 |

The contents specified are percentages by weight with respect to the weight of the frit.

The formulation of the frits F1, F01 and F02, in the form of anhydrous pastes, PA1, PA01 and PA02, respectively, is performed as follows:
to 100 parts by weight of enamel frits (F1, or F01, or F02), add
20 parts by weight of black iron oxide marketed by BAYER under the brand name 303T, and
35 parts by weight of terpenic oil marketed by DRT.

The compositions of the anhydrous pastes PA1, PA01 and PA02 are summarised in Table 2.

TABLE 2

| | Constituent | | |
|---|---|---|---|
| | ANHYDROUS | | |
| | paste PA1 | Control | Control |
| | according to | ANHYDROUS | ANHYDROUS |
| | the invention | paste PA01 | paste PA02 |
| Frit A | 100 | 100 | 100 |
| 303T Black | 20 | 20 | 20 |
| iron oxide | | | |
| Oil (terpenic) | 35 | 35 | 35 |
| Percentage by | 3.23 | 0.97 | 7.74 |
| weight of molten | | | |
| element in | | | |
| anhydrous paste | | | |

Each anhydrous paste PA1, PA01 and PA02 is then applied in a single layer by means of screen printing, on an aluminium substrate. After drying at 80° C. for 30 seconds, the pastes are than oven-dried for 10 minutes at 560° C., to form vitrified enamels. The vitrified enamels EM1, EM01 and EM02 obtained from the anhydrous pastes PA1, PA01 and PA02 respectively, are then subjected to an acid resistance evaluation test, the results of which are given in table 3.

The acid resistance is evaluated as follows:
one drop of a mixture of acids comprising 100 g of distilled water, 20 g of concentrated sulphuric acid and 2 g of oxalic acid is deposited on the enamelled surface;
the whole is left to stand at ambient temperature for 15 minutes; and
the surface corrosion of the enamel is observed.

If the enamel is corroded, this may appear in various ways, for example dulling, or a loss of lustre and staining. A resistant enamel does not display any of these forms of damage, an unacceptable enamel displays at least one of these forms of damage.

TABLE 3

| | Vitrified enamels | | |
|---|---|---|---|
| | EM1 | | |
| | according to | EM01 | |
| | the invention | control | EM02 |
| Percentage by | 4.17 | 1.25 | 10 |
| weight of molten | | | |
| element in | | | |
| enamel layer | | | |
| Acid test | No marks | Discoloration | Dulling |
| resistance | | and loss of | |
| | | lustre | |

The results demonstrates that if the anhydrous paste comprises less than 2% or more than 9% by weight of molten element (V₂O₅ or PbO) with respect to the total weight of the paste, the enamels EM01 and EM02 obtained from said anhydrous pastes are less resistant to acid corrosion than an enamel according to the invention EM1.

### Example 2

A slip was prepared from the enamel frit according to the invention F1, by mixing with 100 parts by weight of frit A1, 56 parts by weight of water, 3.5 parts by weight of boric acid, and 0.8% by weight of potassium carbonate.

The formulations of the frit F1 in the form of slip BA1 and anhydrous paste PA1 are summarised in Table 4.

TABLE 4

Constituents

| | ANHYDROUS paste | |
|---|---|---|
| | PA1 according to | |
| | the invention | Slip BA1 |
| Frit A | 100 | 100 |
| 303T Black | 20 | 10 |
| iron oxide | | |
| Water | — | 56 |
| Boric acid | — | 3.5 |
| Potassium | — | 0.8 |
| carbonate | | |
| MSR oil | 35 | — |
| (terpenic) | | |

The anhydrous paste PA1 according to the invention and the slip BA1 were applied in a single layer by means of screen printing on aluminium substrates.

The paste PA1 and the slip BA1 are then dried for 30 s at 80° C., and oven-dried at 560° C. for 10 minutes, to produce the vitrified enamels EM1 in example 1 and EM03, respectively. These vitrified enamels EM1 and EM03 are then subjected to the acid resistance evaluation test, in the same way as in example 1. The results are given in Table 5.

TABLE 5

Vitrified enamels

| | EM1 | |
|---|---|---|
| | according to | EM03 |
| | the invention | control |
| Acid test | No visible | Discoloration |
| resistance | corrosion | |

The comparison of the acid test resistance of the enamel EM03 with the enamel according to the invention EM1 (performed using the same enamel frit F1) demonstrates that the formulation in slip form results in a less satisfactory resistance to acid corrosion, appearing in the form of discoloration of the enamel.

1. Article of cookware (1, 10) comprising a hollow bowl defining a bottom (3, 30) and a side wall (4, 40) rising from said bottom (3, 30), said bowl having an inner face (1a) capable of receiving foods and an outer face (1b, 10b) intended to be arranged on the side of the heat source, said dish comprising an aluminium or aluminium alloy sheet (5),
characterised in that the outer face (1b, 10b) at least of the side wall (4, 40) is made of anodised aluminium or anodised aluminium alloy,
in that and the outer face (1b, 10b) of the bottom (3, 30) is coated at least partly with an enamel layer (8, 80) having a substantially uniform thickness wherein the mean value is between 15 and 40 μm, with a deviation with respect to said mean thickness value of not more than 10%, and
in that said enamel layer (8, 80) comprises 1.5 to 9% by weight with respect to the total weight of the enamel layer of at least one molten element selected from the group consisting of lead oxide PbO, bismuth oxide Bi₂O₃ and vanadium pentoxide V₂O₅.

2. Article of cookware (1, 10) according to claim 1, characterised in that said enamel layer (8, 80) comprises 4 to 6% by weight with respect to the total weight of the enamel layer (8, 80) of vanadium pentoxide.

3. Article of cookware (1, 10) according to claim 1, characterised in that the inner face (1a) of the article of cookware (1, 10) according to the invention may be provided with a non-stick coating (6), which is arranged so as to be in direct contact with the aluminium sheet (5).

4. Article of cookware (1, 10) according to claim 3, characterised in that the non-stick coating (6) is obtained using a composition comprising a thermostable resin resistant to at least 200° C.

5. Article of cookware (1, 10) according to claim 4, characterised in that the thermostable resin resistant to at least 200° C. is a silicone resin or a fluorocarbon resin such as PTFE.

6. Article of cookware (1, 10) according to claim 1, characterised in that the sheet (5) is an embossed sheet having the final shape of the article (1, 10).

7. Article of cookware (1, 10) according to claim 1, characterised in that the enamel layer has a mean thickness between 20 and 30 μm.

8. Article of cookware (1, 10) according to claim 1, characterised in that the outer face (1b, 10b) of the bottom (3, 30) comprises a plate (7, 70) centred on the bottom (3, 30) and covering at least a portion (5a) of the sheet (5), the plate (7, 70) being made of a metal or a material coated with a metal, a carbide or nitride of the same metal, said metal being selected so as to withstand an anodising step.

9. Article of cookware (1, 10) according to claim 8, characterised in that the metal of the plate (7, 70) is selected from the transition metals such as titanium, zirconium or niobium, the material forming, if applicable, the core thereof which is coated with said metal or a carbide or nitride of the same metal, being selected from steel, stainless steel, ferritic or not.

10. Article of cookware (1, 10) according to claim 1, characterised in that the bottom (3, 30) of the article of cookware (1, 10) being slightly concave, the zone of the bottom (3, 30) intended to be in contact with the heat source is completely coated with the enamel layer (8, 80).

11. Article of cookware (1, 10) according to claim 1, characterised in that the outer face (1b, 10b) of the side wall (4, 40) is partially coated with a discontinuous enamel layer forming a décor.

12. Method to manufacture an article of cookware (1, 10) comprising a bottom (3, 30) and a side wall (4, 40) rising from the bottom (3, 30) made of aluminium or aluminium alloy, said method comprising the following steps:
a) shaping, by means of embossing, of an aluminium or aluminium alloy sheet (5) to give it the final shape of the article of cookware (1, 10) and thus define the inner face (1a) of the article of cookware (1, 10), intended for cooking food, and the outer face (1b, 10b) of the article of cookware (1, 10) intended to be arranged on the side of the heat source;
b) an enamel layer (8, 80) production step on all or part of the outer face (1b, 10b) of the bottom (3, 30) of the article of cookware (1, 10), and
c) an anodising step c) of the article of cookware (1, 10),
said method being characterised in that said enamel layer (8, 80) production step b) is performed before the anodising step and represents the only enamelling step of the outer face of the bottom of the article of cookware according to the invention, said step b) comprising the following successive steps:
i) preparation of an anhydrous paste from a powdery enamel frit comprising 0.82 to 6.75% by weight with respect to the total weight of the paste of at least one molten element selected from the group consisting of lead oxide PbO, bismuth oxide Bi₂O₃ and vanadium pentoxide V₂O₅, said paste being formulated in the form of a dispersion in a non-aqueous medium;
ii) application of the anhydrous paste on said outer face (1b, 10b) of the bottom (3, 30) in at least one layer of paste;
iii) firing of the layer of paste at a temperature between 540° C. and 575° C. to form an enamel layer (8, 80) having after firing a substantially uniform thickness wherein the mean value is between 15 and 40 μm with a deviation with respect to said mean thickness value of not more than 10%.

13. Method according to claim 12, characterised in that said anhydrous paste comprises 55 to 75% by weight of powdery enamel frit with respect to the total weight of the anhydrous paste.

14. Method according to claim 13, characterised in that said anhydrous paste comprises 65% by weight of powdery enamel frit with respect to the total weight of the anhydrous paste.

15. Method according to claim 12, characterised in that the enamel frit comprises:
SiO₂: 30 to 38%;
V₂O₅: 3 to 7;
NaOH: 15 to 25%;
LiOH: 0.5 to 4%;
KOH: 8 to 17%;
TiO₂: 18 to 25%;
the contents specified being percentages by weight with respect to the weight of the frit.

16. Method according to claim 12, characterised in that the non-aqueous medium wherein the enamel frit is dispersed in an oily medium or a solvent.

17. Method according to claim 12, characterised in that the paste has a viscosity of 2000 to 8000 cP, and in that the anhydrous paste is applied by means of screen printing or by means of stamp printing.

18. Method according to claim 12, characterised in that the anhydrous paste is applied in a single layer, to form an enamel layer having after firing a mean thickness between 15 and 30 μm.

19. Method according to claim 12, characterised in that the anhydrous paste is applied in two layers, so as to produce an enamel layer having after firing a thickness between 25 and 40 μm.

20. Method according to claim 12, characterised in that the firing of said anhydrous paste is performed at a temperature of approximately 560° C.

21. Method according to claim 12, characterised in that the anodising is performed by tempering the article of cookware in a sulphuric acid bath, alone or in a mixture with oxalic acid, and with an acid bath temperature between −5° C. and 25° C.

22. Method according to claim 21, characterised in that the acid bath temperature is −5° C.

23. Method according to claim 12, characterised in that, after the shaping step a) of the sheet (5) and before the production step b) of an enamel layer (8, 80) on the outer face (1b, 10b) of the bottom (3, 30), the die stamping application on the outer face (1b, 10b) of the bottom (3, 30), of a plate (7, 70) intended to cover a portion (5a) of the sheet (5) is performed, said plate (7, 70) being made of a metal or a material coated with a metal or a carbide or a nitride of the same metal, said metal being selected such that the plate (7, 70) withstands the anodising step c).

24. Method according to claim 12, characterised in that, after the production step b) of an enamel layer (8, 80) on all or part of the outer face (1b, 10b) of said article (1, 10) and before the anodising step c) of said article (1, 10), the deposition on the inner face (1a) of the article (1, 10) of at least one layer intended to form, after firing, a non-stick coating (6) is performed.

25. Method according to claim 24, characterised in that a composition comprising a thermostable resin resistant to at least 200° C. is used to form the first non-stick coating (6).

26. Method according to claim 25, characterised in that the thermostable resin resistant to at least 200° C. is a silicone resin or a fluorocarbon resin such as PTFE.
